(19) United States
(12) Patent Application Publication
(10) Pub. No.: US 2012/0155665 A1
(43) Pub. Date: Jun. 21, 2012

(54) Echo Canceller With Adaptive Non-Linearity

(76) Inventor: Udayan Kande, Pune (IN)

(21) Appl. No.: 13/392,105

(22) PCT Filed: Aug. 24, 2010
(86) PCT No.: PCT/IB2010/053806

§ 371 Date: Feb. 24, 2012

(30) Foreign Application Priority Data
Aug. 24, 2009 (IN) 1943/MUM/2009

(51) Int. Cl. H04B 3/20

(52) U.S. Cl. 381/66

(57) ABSTRACT

An echo canceller (1399) with adaptive non-linearity is disclosed. In an embodiment, an incoming signal (1301) coming in from the far end is passed to a probe signal adder, which may add a probe signal to the incoming signal and may perform other signal conditioning before passing the signal to a playback device (1304). A recording device (1310) picks up a part of the signal generated by the playback device and also picks up other sounds/physical phenomena from its environment. An echo remover creates an estimate of the signal picked up by the recording device from its environment alone without the signal generated by the playback device. The echo remover creates this estimate by using the signal going towards the playback device and the signal recorded by the recording device. A linear filter estimator (1342) generates an estimate of the linear filter section of the environment, which may be used by the echo remover.

This application claims priority from provisional patent application 1943/MUM/2009 titled “Echo Canceller with Adaptive Non-Linearity” filed in Mumbai, India on 24 Aug. 2009.

### TECHNICAL FIELD

The present invention relates to echo cancellation.

### BACKGROUND ART

Echo cancellation is needed in many applications such as telephones, two-to-four-port networks, signal repeaters, telephony and internet telephony, speak-erphones and conference phones, non-intrusive video conferencing, etc.

### SUMMARY

An echo canceller with adaptive non-linearity is disclosed. In an embodiment, an incoming signal coming in from the far end is passed to a probe signal adder, which may add a probe signal to the incoming signal and may perform other signal conditioning before passing the signal to a playback device. A recording device picks up a part of the signal generated by the playback device and also picks up other sounds/physical phenomena from its environment. An echo remover creates an estimate of the signal picked up by the recording device from its environment alone without the signal generated by the playback device. The echo remover creates this estimate by using the signal going towards the playback device and the signal recorded by the recording device. A linear filter estimator generates an estimate of the linear filter section of the environment, which may be used by the echo remover.

The above and other preferred features, including various details of implementation and combination of elements are more particularly described with reference to the accompanying drawings and pointed out in the claims. It will be understood that the particular methods and systems described herein are shown by way of illustration only and not as limitations. As will be understood by those skilled in the art, the principles and features described herein may be employed in various and numerous embodiments without departing from the scope of the invention.

### BRIEF DESCRIPTION OF DRAWINGS

The accompanying drawings, which are included as part of the present specification, illustrate the presently preferred embodiments and together with the general description given above and the detailed description of the preferred embodiments given below serve to explain and teach the principles of the present invention.

FIG. 1 depicts a block diagram of an echo canceler, according to one embodiment.

FIG. 2 depicts a model of the playback and record device environment used to remove echo, according to one embodiment.

FIG. 3 depicts an echo remover, according to one embodiment.

FIG. 4 depicts an echo remover, according to one embodiment.

FIG. 5 depicts an adaptive non-linearity, according to one embodiment.

FIG. 6 depicts an adaptive non-linearity, according to one embodiment.

FIG. 7 is a graph showing a set of example constituent functions of a composite non-linear function, according to one embodiment.

FIG. 8 is a graph showing a set of example scaled constituent functions of a composite non-linear function, according to one embodiment.

FIG. 9 depicts an adaptive non-linearity, according to one embodiment.

FIG. 10 depicts a probe signal adder, according to one embodiment.

FIG. 11 depicts a probe signal adder, according to one embodiment.

FIG. 12 depicts a linear filter estimator, according to one embodiment.

FIG. 13 depicts an echo canceller, according to one embodiment.

### DETAILED DESCRIPTION

An echo canceller with adaptive non-linearity is disclosed. In an embodiment, an incoming signal coming in from the far end is passed to a probe signal adder, which may add a probe signal to the incoming signal and may perform other signal conditioning before passing the signal to a playback device. A recording device picks up a part of the signal generated by the playback device and also picks up other sounds/physical phenomena from its environment. An echo remover creates an estimate of the signal picked up by the recording device from its environment alone without the signal generated by the playback device. The echo remover creates this estimate by using the signal going towards the playback device and the signal recorded by the recording device. A linear filter estimator generates an estimate of the linear filter section of the environment, which may be used by the echo remover.

FIG. 1 depicts a block diagram of an echo canceller 199, according to one embodiment. The echo canceller comprises signals and signal processing blocks. The processing blocks may be implemented as analog or digital circuits, or in one or more processors. In digital or processor implementations, the computations may be performed in integers, fixed point or floating point or other numerical formats. The signals may be analog, digital or comprise electronic memory storage or storage. The incoming signal 101 from the far end is passed to a probe signal adder 102, which may add a probe signal to the signal from the far end 101 and may perform other signal conditioning before passing it to the playback device 104 as signal 103. The playback device 104, such as a speaker or other actuation device, produces a version of the signal 103 as audio or other physical phenomenon in an environment. Part of this generated audio or physical phenomenon is picked up by recording device 110, which also picks up other sounds/physical phenomena from its environment. The echo remover 107 creates an estimate of the signal picked up by recording device 110 without the effect generated by the playback device 104, and sends it as outgoing signal 112. The echo remover 107 creates this estimate by using the signal 103 going towards the playback device 104 and the signal 111 recorded by the recording device 110. The linear filter estimator 106 generates an estimate of the linear filter section of the environment, which may be used by the echo remover 107.

The echo remover 107 may optionally create estimates such as an estimate 109 of the input signal to the linear filter section of the environment. The echo remover 107 may also create an estimate of the output signal of the linear filter section or an estimate of the signal entering the recording device or an estimate of the output signal of the linear section after addition of other sound/signal, one or more of which could be provided as input 108 to the linear filter estimator 106.

The probe signal adder 102 optionally creates an estimate 105 of the effect of the added probe signal at the input of the linear filter section 105, which may be used by the linear filter estimator 106. To produce this estimate 105 of the effect of the added probe signal at the input of the linear filter section 105, it may use the estimate 109 of the input signal to the linear filter section 109.

The linear filter estimator 106 may use the estimate 105 of the effect of the added probe signal at the input of the linear filter section, the signal 103 going towards the playback device 104 and the estimate 108 of the output signal of the linear section after addition of other sound/signal to generate the estimate of the linear filter section of the environment, which may be used by the echo remover 107.

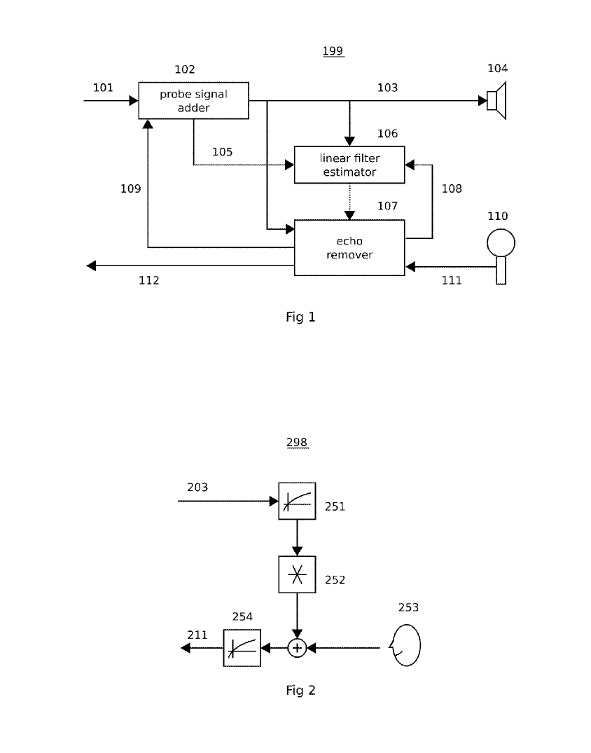

FIG. 2 depicts a model 298 of the playback and record device environment used to remove echo, according to one embodiment. The process that occurs in the environment in which the playback and record devices are present is mathematically approximated as the model 298. The actual physical environment may be different from the mathematical model. The mathematical model approximates the changes to the signal 203 (that goes into the playback device) that convert it into the signal 211 coming out of the recording device. The mathematical model may include the changes caused by the playback device, the recording device, the environment or the channel between the playback and recording devices and other signal sources.

The signal 203 passes through an optional non-linear block 251. The non-linear block 251 comprises a non-linear function, which converts input signal values to output signal values. The non-linear block 251 may also comprise a linear filter applied before the non-linear function. A linear filter is a linear function of the present and past values of the input and past values of the output of the linear filter. The non-linear block may also comprise an analysis filter bank which separates the input signal into frequency bands followed by a (possibly different) non-linear function applied to the output of each filter bank, followed by an addition of such outputs.

The signal then passes through a linear filter 252. The linear filter 252 is a linear function of the present and past values of the input and past values of the output of the linear filter 252.

Sound or signal produced by other signal sources such as source 253 is added to the output of the linear filter 252.

This signal then passes through an optional non-linear block 254. The non-linear block 254 comprises a non-linear function, which converts input signal values to output signal values. The non-linear block 254 may also comprise a linear filter applied after the non-linear function. A linear filter is a linear function of the present and past values of the input and past values of the output of the linear filter.

The output of this non-linear block, the signal 211 is approximately the signal coming out of the recording device. This signal 211 will then travel through an echo remover, to produce an estimate of the sound/signal produced by the other signal sources such as source 253 without the effect of the signal 203. The echo remover may produce an estimate of the sound/signal of source 253 as it would be produced after passing through the non-linear block 254 or as it would be without/before passing through the non-linear block 254.

The model 298 is a parametric model of the environment, since the working of the non-linear blocks 251 and 254 and of the linear filter 252 may depend on many parameters. For example, the linear filter 252 may be estimated as a finite impulse response convolution, whose response is parametrized by the filter coefficients, i.e. the numbers by which the present and past input values are to be multiplied. The linear filter 252 may also be estimated as a multiplication in the frequency domain, wherein the frequency response at various frequencies are the parameters. The linear filter may also be estimated as an infinite impulse response filter, such as a pole-zero, ARMA or recursive filter, with corresponding parameters.

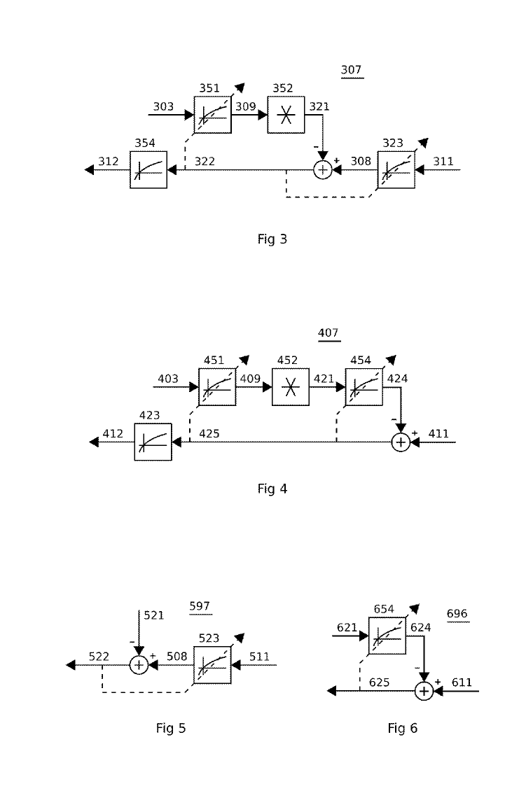

FIG. 3 depicts an echo remover 307, according to one embodiment. The echo remover 307 uses the signal 303 going towards the playback device and the signal 311 coming from the recording device, to produce signal 312 which is an estimate of the signal picked up by the recording device. The signal 303 passes through an optional non-linear block 351 to give signal 309, which is an estimate of the input signal to the linear filter section of the environment model. This estimate of the input signal to the linear filter model may also be given to the probe signal adder. The signal 303 may itself be used as the estimate of the input signal to the linear filter section of the environment model. The signal 309 then passes through a linear filter 352 to give signal 321, which is an estimate of the output signal of the linear filter section of the environment model. The signal 311 passes through an optional non-linear block 323 which is approximately an inverse of the non-linear block after the linear filter section of the environment model, to produce signal 308 which is an estimate of the output signal of the linear section after addition of other sound/signal. The estimate of the output signal of the linear filter 321 is subtracted from the estimate of the output signal of the linear section after addition of other sound/signal 308, to give an estimate of the other sound or signal 322. This signal 322 may be directly used as the output of the echo remover (signal 312), which is an estimate of the signal picked up by the recording device.

Alternatively, the signal 322 may be passed through a non-linear block 354 to give signal 312. The non-linear block 354 is an estimate of the non-linear block after the linear filter in the environment model. The signal 312 is an estimate of how the other sound/signal alone would have excited the non-linear block after the linear filter. Non-linear blocks 354 and 323 are exact or approximate inverses of each other. If non-linear block 354 is not used, then only non-linear block 323 which is the approximate inverse of the non-linear block after the linear filter is in the signal path, which serves to correct the non-linearity and other distorting characteristics of the recording device. If non-linear block 354 is used, it emulates the characteristics of the recording device, thus producing a truer representation of how the other sound/signal would have been recorded alone (unadulterated by the signal from the playback device). Using non-linear block 354 also corrects non-linearity introduced by the non-linear block 323. In an embodiment, while the non-linear block 323 is adapting to become an estimate of the inverse of the non-linear block after the linear filter, the non-linear block 354 is used so that non-linearity introduced by mis-adaptation is mitigated. Once the non-linear block 323 is well adapted, the non-linear block 354 is not used. Instead of suddenly turning off non-linear block 354 and thus introducing a glitch in the signal, the response of the non-linear block may be tapered towards zero. Thus, in general, the non-linear block 354 is a weighted intermediate of the following two things: an estimate of the non-linear block after the linear filter in the environment model and the identity function. The weighting favors the estimate of the non-linear block during adaptation of the non-linear block 323 and favors the identity function when the non-linear block 323 is well adapted.

In an embodiment, the parameters of the non-linear block 351 are chosen so as to minimize some function of the signal 322, such as the mean squared value of the signal 322. This may be done prior to or during the running of the echo remover 307. In an embodiment, the non-linear block 351 corresponds to the transfer characteristics of the playback device, and thus, for a particular playback device, a particular set of parameters may be well suited. If the playback device is unchanging, the adaptation of the parameters of the non-linear block 351 during the running of the echo remover 307 may not be necessary, or the adaptation may be performed very slowly, or the adaptation may be performed starting from a set of parameters which model that particular playback device or that class of playback devices well.

In an embodiment, the parameters of the non-linear block 323 are chosen so as to minimize some function of the signal 322, such as the mean squared value of the signal 322. This choice of parameters may be done prior to or during the running of the echo remover 307. In an embodiment, the non-linear block 323 corresponds to an approximate inverse of the transfer characteristics of the recording device, and thus, for a particular recording device, a particular set of parameters may be well suited. If the recording device is unchanging, the adaptation of the parameters of the non-linear block 323 during the running of the echo remover 307 may not be necessary, or the adaptation may be performed very slowly, or the adaptation may be performed starting from a set of parameters which model that particular recording device or that class of recording devices well.

In an embodiment, the parameters of the linear filter 352 are chosen so as to minimize some function of the signal 322, such as the mean squared value of the signal 322. In another embodiment, the parameters of the linear filter 352 are chosen by a linear filter estimator.

FIG. 4 depicts an echo remover 407, according to one embodiment. The echo remover 407 uses the signal 403 going towards the playback device and the signal 411 coming from the recording device, to produce signal 412 which is an estimate of the signal picked up by the recording device. The signal 403 passes through an optional non-linear block 451 to give signal 409, which is an estimate of the input signal to the linear filter section of the environment model. The signal 409 then passes through a linear filter 452 to give signal 421, which is an estimate of the output of the signal of the linear filter section of the environment model. The signal 421 then passes through an optional non-linear block 454 to give signal 424, which is an estimate of how the signal entering the playback device alone would have been picked up by the recording device. This signal 424 is subtracted from the signal 411 recorded by the recording device, to give signal 425, an estimate of how the other signal alone would have been picked up by the recording device. This signal 425 either directly becomes the output of the echo remover (signal 412), or passes through a non-linear block 423 to become the output signal 412. The non-linear block 423 is an estimate of the inverse of the non-linear block after the linear filter in the environment model, and is approximately or exactly the inverse of non-linear block 454.

In an embodiment, the parameters of non-linear block 451, or the parameters of the non-linear block 454 or the parameters of the linear filter 452 are chosen so as to minimize some function of the signal 425, such as the mean squared value of the signal 425. In another embodiment, the parameters of the linear filter 452 are chosen by a linear filter estimator.

FIG. 5 depicts an adaptive non-linearity 597, according to one embodiment. Signal 511 is acted upon by non-linear block 523 to give signal 508. Another signal 521 is subtracted from signal 508 to give signal 522. The parameters of the non-linear block 523 are chosen so as to minimize some function of the signal 522, such as the mean squared value of the signal 522. This minimization may be done by gradient descent or by estimated gradient descent, that is by estimating the gradient and moving against that direction.

In an embodiment, the non-linear block 523 implements a composite non-linear function f which is a linear combination of certain constituent functions f1 to fn, i.e.,

signal508=f (signal511)=a1 f1(signal511)+a2 f2(signal511)+ . . . an fn (signal511)

where a1, . . . an are the parameters which choose the function f implemented by the non-linear block 523. For particular choices of the parameters, the function f may even be linear. The error signal, signal 522 is

signal522=signal508−signal521

In an embodiment, we are minimizing the mean squared error, i.e. the mean squared signal 522, i.e.

E [(signal522)̂2]

whose derivative with respect to a parameter ai is

(d/(d ai)) E [(signal522)̂2)]=2 E [(signal522) fi (signal511)]

The parameter ai may be updated in the negative direction of the above derivative. The above derivative may be multiplied by a small positive number s, the step size multiplier before such update of ai. I.e., the following number is added to ai to move ai towards a value such that the error signal 522 has minimum mean squared value.

−2 s E [(signal522) fi (signal511)]

This update may be performed repeatedly to move ai closer and closer to its best value. Such update may be performed for all indexes i from 1 to n. The mean E [(signal522 fi (signal511)] may be estimated for a given set of parameters {a1, . . . an} if we know the values of signal511 and corresponding values for signal521 (from which signal522 can be calculated). Alternatively, the present values of signal522 and signal511 may be used directly in an estimate of the required mean:

E [(signal522) fi (signal511)]≈(signal522) fi (signal511)

In this way, ai is updated by adding the following value to it:

−2 s (signal522) fi (signal511)

This update may be performed per time index for each index i from 1 to n. There may also be limits to the values that the parameters {a1, . . . an} are allowed to take. If any of these limits are crossed, the parameters may be updated to bring them within the specified bounds.

In an embodiment, for a certain value of signal 511, only certain of the functions {f1, . . . fn} may be non-zero. In this case, the updating of parameters will only affect those parameters for which the function is non-zero for that particular value of signal 511, and thus, the updating may be performed for only those parameters.

In an embodiment, the parameters of the non-linear block 523 are chosen to minimize a value which is a function of the signal 522 as well as a function of the parameters themselves. For example the parameters may be chosen to minimize the value

E [(signal522)̂2]+r ((0−a1)̂2+(a1−a2)̂2+(a2−a3)̂2+ . . . (an−0)̂2)

where r is some constant. Choosing the above function to minimize implies that the the parameters will be chosen so as to minimize the mean squared signal 522, but also in such a way that the difference between consecutive parameter values is less. In the case of the above function, the derivative with respect to a parameter ai is

2 E [(signal522) fi (signal511)]+2 r (−a(i−1)+2 a (i)−a(i+1))

where a0=a(n+1)=0. Thus, ai is updated by adding the following value to it:

−2 s (signal522) fi (signal511)+2 r s (a(i−1)−2 a (i)+a(i+1))

The step size multiplier s may be a constant, or it may change depending on the adaptation circumstances. A higher choice of s leads to faster convergence, while a lower choice of s leads to better convergence. Thus, during adaptation or readaptation, s may be chosen to be a higher value, and during well-adapted running s may be chosen to be a lower value. Furthermore, the value of s may be changed slowly from its minimum to maximum value (or the other way around), by updating it additively or multiplicatively by a small amount. Whether the current parameters are well-adapted or are still adapting may be decided based upon whether the updates to the values of the parameters are all in a single direction, or they are in completely random directions. For example, if the past few updates to a particular parameter have the same sign, the parameter may be deemed to be adapting and a larger s could be used for that or all rameters.

The step size multiplier may (apart from a factor which changes with the well-adaptedness as specified above) also have a factor which is the reciprocal of the statistical second moment of the value to which the parameter is applied as a weight. In the present case, the step size multiplier may have a factor which is the reciprocal of the statistical second moment of fi (signal511). This statistical second moment may be statistics generated over a part (or whole) of the signal 511, inclusive of or exclusive of those signal elements for which the value of signal 511 dictates that fi will produce a zero value. This inverse weighting of the step size multiplier (which will produce different step size multipliers for different i) normalizes the step size to become scale independent. If the values of fi are within a narrow range, a representative value of the second moment (possibly the second moment assuming a uniform input over the narrow range) may be fixed and used, instead of computing the second moment from actual data.

Not only the second moments, but the correlations between the outputs of various constituent functions may also be computed. The second moments and the correlations together give a correlation matrix, the inverse of which maybe acted upon the unnormalized update vector (having updates for each i) to produce a normalized update vector.

FIG. 6 depicts an adaptive non-linearity 696, according to one embodiment. Signal 621 is acted upon by non-linear block 654 to give signal 624 which is subtracted from signal 611 to give signal 625. The parameters of the non-linear block 654 are chosen so as to minimize some function of the signal 625, such as the mean squared value of signal 625. In an embodiment, the non-linear block 654 implements a composite function f which is a linear combination of certain constituent functions f1 to fn:

signal624=f (signal621)=a1 f1 (signal621)+ . . . an fn (signal621)

In an embodiment, we wish to minimize the mean square error (i.e. mean squared signal 625) whose derivative with respect to a parameter ai is

(d/(d ai)) E [(signal625)̂2]=−2 E [(signal625) fi (signal621)]

The parameter ai may be updated a small increment in the negative of this direction, i.e. by the number

2 s E [(signal625) fi (signal621)]

an expected value which may be approximated by its present signal value, i.e.

2 s E [(signal625) fi (signal621)]

All embodiments of adaptive non-linearity wherein the non-linearity contributes positively to the error signal can be carried over with a change of sign as appropriate to the case of adaptive non-linearity wherein the non-linearity contributes negatively to the error signal.

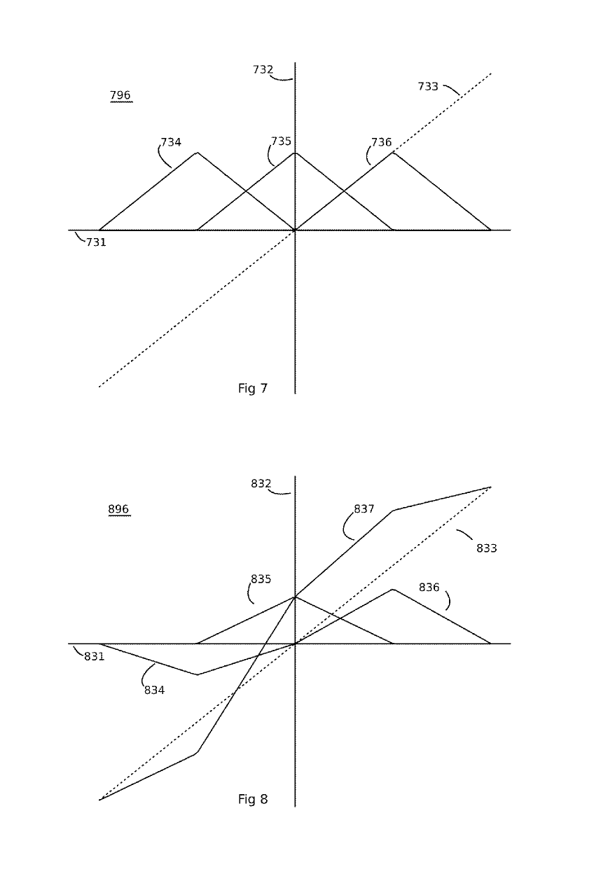

FIG. 7 is a graph showing a set 796 of example constituent functions of a composite non-linear function, according to one embodiment. The horizontal axis 731 represents input values, and the vertical axis 732 represents output values. The set of possible input values is divided into four equal parts. Each of the functions 734, 735 and 736 rises linearly in one part, and falls linearly in the next adjacent part, and is zero in all the other parts. The function 733 is a linearly rising function encompassing the whole range of values. The composite non-linear function (not shown) is a linear combination of these four constituent functions, weighted by some parameters.

In various embodiments of the present invention, the input values may be divided into more than or less than four parts (and corresponding, more or less number of constituent functions used), or the parts may not be equal in size.

In an embodiment, the input values are coded as integers or fixed point or floating point numbers. Inspection of a few most significant bits of the integer or fixed point input (or of the exponent and most significant few bits of a floating point input) gives the part of the range that a particular input falls within. For example, if the whole range corresponds to 16-bit signed integers, and the range is divided into four parts, the most significant bit (sign bit) and the next most significant bit decide which part the input falls within. If the range is divided into eight parts, it is the 3 most significant bits. Once the part of the range that a particular input falls within is fixed, this information fixes the constituent functions that will be non-zero (including the linear function 733), and all other constituent functions will be zero.

This set of example constituent functions creates a piecewise linear composite non-linear function, which can be thought of as a linear interpolation between parametrized values. Other bases pertaining to quadratic interpolation, cubic interpolation, quadratic blending, sync interpolation, etc. may be used. Similarly bases for spline interpolation, Bernstein bases, Bezier blending functions, B-spline bases etc. may also be used.

Bases which are non-local, such as polynomial, Fourier, Chebychev etc. may also be used. The Legendre basis, created to be orthogonal over the range of input values, or over a smaller range of values may be used.

Each piece may also be estimated as a cubic spline, and adjoining pieces may have value and derivative continuity. The corresponding cubic spline blending functions are used as basis functions.

FIG. 8 is a graph showing a set 896 of example scaled constituent functions of a composite non-linear function, according to one embodiment. The horizontal axis 831 represents input values, and the vertical axis 832 represents output values. Functions 833, 834, 835 and 836 are constituent functions scaled by parameters. The function 837 is the composite non-linear function which is a sum of the functions 833, 834, 835 and 836.

In an embodiment, the weight (parameter) applied to the function 833 is limited to a single value or a narrow range. (If it is limited to a single value, then adaptation/optimization of this parameter need not be performed). In this way, the graph of the composite non-linear function 837 will be slight modifications of a fixed function 833. The function 833 may be a linear function, or it may be a general approximation of the non-linear characteristics of a class of devices. For example, if the present invention is to be employed in a situation in which it is known that a particular device having a particular characteristic will be used (such as, say, a class A amplifier), a function suitable to that device may be chosen as function 833.

In an embodiment, the weights applied to the constituent functions are constrained such that the composite function 837 does not deviate too much from the function 833.

In an embodiment, the weights applied to the constituent functions are constrained so as to guarantee that the composite function 837 remains monotonic, and thus invertible. For example, if the constituent functions are piecewise linear, as described, and have positive or negative unit slope in the non-zero pieces, then the slope of a piece of the composite function 837 will be one (of the linear function 833) plus the parameter of the constituent function having rising slope in that part minus the parameter of the constituent function having falling slope in that part. Keeping this slope positive for each piece guarantees that the composite function 837 will be monotonic. Thus, a parameter for a constituent function having a rising slope in a particular part minus the parameter for the constituent function having a falling slope in the same part should be greater than negative unity for the composite function 837 to be monotonic.

In an embodiment, the weights applied to the constituent functions are constrained so as to guarantee that the composite function 837 has a slope not greater than a particular value, or not less than a particular value. This constrains the shape of the composite function 837 to not vary too much from the original shape of 833. It also allows the composite function 837 to be invertible in an arithmetically stable way.

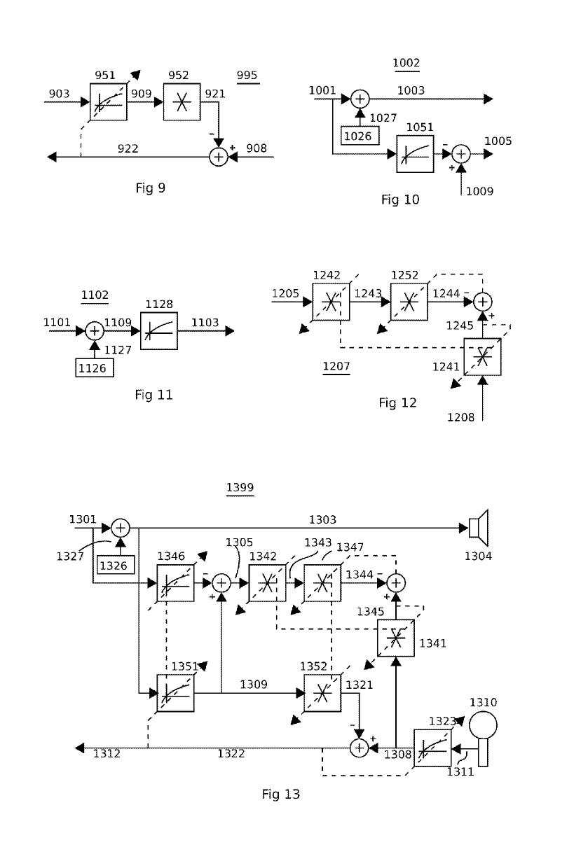

FIG. 9 depicts an adaptive non-linearity 995, according to one embodiment. The signal 903 is acted upon by non-linear block 951 to give signal 909, which is acted upon by linear filter 952 to give signal 921 which is subtracted from signal 908 to give signal 922. In an embodiment, the parameters governing the non-linear block 951 are chosen so as to minimize some function of the signal 922, such as the mean squared value of the signal 922 (mean squared error). The signal 922 may be written as:

signal922=signal908−signal921

signal922=signal908−(signal909*h)

signal922=signal908−(f(signal903)*h)

signal922=signal908−((a1 f1 (signal903)+a2 f2 (signal903)+ . . . an fn (signal903))*h)

signal922=signal908(a1 (f1 (signal903)*h)+a2 (f2(signal903)*h)+ . . . an (fn (signal903)*h))

where * stands for convolution, h is the impulse response of the linear filter 952, and {f1, . . . fn} is the set of constituent functions whose linear combination gives the composite function f implemented by the non-linear block 951, the linear combination weighted according to the parameters {a1, . . . an}. To minimize the mean squared error E [(signal922)̂2], we find its derivative with respect to a parameter ai, which is

(d/(d ai)) E [(signal922)̂2]=−2 E [(signal922)(fi(signal903)*h)]

The above expected value may be calculated using statistical techniques, or alternatively the present value of the variables may be used as an estimate. In an embodiment, the parameter is updated by a small amount in the negative direction of this estimated derivative, i.e. the parameter ai has the following value added to it

2 s (signal922) (fi (signal903)*h)

All parameters will be updated in this way. In an embodiment, the convolution (*h) is performed by summing over time indexes the product of the past value of fi (signal903) and the appropriate filter coefficient of the impulse response h. In the case that only a few of the fi's will be non-zero for any particular value of signal 903, it is advantageous to update all the parameters in a single loop. Thus, for each historical time index, the value of signal 903 determines which constituent functions fi will be non-zero, and “2s(signal922)(fi(signal903) h)” is added to the corresponding ai, where the present value of signal 922, the appropriate past value of signal 903 and the appropriate coefficient of h is used.

In an embodiment, the convolution in the update for the parameter ai is performed using the Fourier transform technique, i.e. taking the fast Fourier transform of both the signals (with appropriate padding), multiplying component-wise in the Fourier domain, and taking the fast inverse Fourier transform of the component-wise multiplication. The computation of the signal922 itself requires one or more convolutions, which may be performed by the Fourier transform technique. For the Fourier transform technique to be effective, a block of signal values have to be treated together. In an embodiment, the update estimate from a particular block of signal values is performed multiple times. Thus, the convolution, multiplication by signal 922 and updation of parameters is performed. These parameters are used to calculate an updated signal 922, from which the multiplication by signal 922 and updation of parameters may be performed again, and so forth. In an embodiment, the parameters of the linear filter 952 (defining h) may be updated during each such iteration too. In this case, the convolution has to be performed every time, since h has changed. The Fourier transform of fi (signal903) need not be recalculated. In an embodiment, parameters governing signal 908 (for example if the signal 908 is generated by an adaptive non-linearity acting on another signal) may be updated during such iteration, in which case the signal 922 has to be re-calculated with the updated signal 908. In an embodiment, various step size multipliers are used (from large to small) during such iteration, thus giving large range and good convergence.

In block based parameter updation, updated parameters for each sample are not available. Parameters are calculated after processing a whole block of values. To avoid abrupt changes in parameters, the parameters may be applied to various samples within a block by interpolating between the earlier and new parameter values.

FIG. 10 depicts a probe signal adder 1002, according to one embodiment. The probe signal adder 1002 adds a probe signal 1027 to an incoming signal 1001 to produce signal 1003 which may be sent to the playback device. (Alternatively, the probe signal is not added). Probe signal generator 1026 generates probe signal 1027. The probe signal 1027 may be a random or pseudorandom noise signal. The signal may be white noise, or it may be correlated noise, which can be generated by passing white noise through a filter. The signal may be added such that the probe signal is inaudible or barely audible. The signal may be added such that the signal is masked by the incoming signal 1001. For example, the amplitude of the signal 1027 may be chosen such that the signal has power a particular number of decibels lower than the current estimated power of signal 1001. Furthermore, such choice of amplitude may be made dependent on the frequency, i.e. the amplitude of the signal 1027 around a certain central frequency (or in a particular band of frequencies) may be chosen based on current estimated power of signal 1001 around the same central frequency (in the same band of frequencies). In an embodiment, noise is added to a band if the actual sound/signal in that band is very low or absent. The addition of probe signal is done to ensure presence of signal in all frequency bands, without which a linear filter may not adapt correctly.

In an embodiment, a larger signal amplitude probe signal 1027 is added during adaptation of the linear filter parameters, than is added when the linear filter parameters are well adapted. It may be assumed that in the beginning, the parameters are not adapted, but after some fixed time, they are well adapted. Whether the linear filter parameters are adapted or not may be estimated based on the same techniques used to choose the step size multiplier for the linear filter adaptation or for other components.

In an embodiment, a signal amplitude is chosen for probe signal 1027 so that the signal amplitude of the corresponding probe signal before the linear filter in the environment model is a constant, or is chosen according to the criteria specified above. This may be done by multiplying the required amplitude by the reciprocal of the slope of the non-linearity before the linear filter in the environment model, evaluated at the input value of signal 1001.

The probe signal adder 1002 may also provide an estimate 1005 of the effect of the added probe signal at the input of the linear filter section. In an embodiment, the probe signal 1027 is itself provided as an estimate 1005 of the effect of the added probe signal at the input of the linear filter section. In another embodiment, the probe signal 1027 is multiplied by the slope of the non-linearity before the linear filter in the environment model to produce the estimate 1005. The non-linearity before the linear filter is estimated to be the non-linearity before the filter estimated by the echo remover.

In another embodiment (depicted), the incoming signal 1001 is passed through a non-linear block 1051, such non-linear block estimating the non-linearity before the filter in the environment model, the parameters for such non-linear block being estimated by the non-linearity before the linear filter in the echo remover, and then this signal is subtracted from a signal 1009, the signal 1009 being an estimate of the input signal to the linear filter section, either calculated by the echo remover, or calculated by the probe signal adder by passing the signal 1003 through a non-linear block estimated to be the non-linearity before the linear filter in the environment model.

The signal 1003 may be further processed by passing it through a non-linear block before providing it to the playback device, such non-linear block being an approximate inverse of the estimated non-linearity before the linear filter in the environment model.

FIG. 11 depicts a probe signal adder 1102, according to one embodiment. The probe signal adder 1102 adds a probe signal 1127 generated by a probe signal generator 1126 to incoming signal 1101 to give signal 1109, which is an estimate of the input to the linear filter section of the environment model. This signal 1109 is then passed through a non-linear block 1128, the non-linear block 1128 being an approximate or exact inverse of an estimate of the non-linearity before the linear filter section in the environment model, to give signal 1103 which may be sent to the recording device. By processing with the non-linear block 1128, the imperfections of the playback device may be reduced, and the fidelity of reproduction increased.

FIG. 12 depicts a linear filter estimator 1207, according to one embodiment. The linear filter estimator estimates the linear filter 1252 that best estimates a signal input 1208 as another signal input 1205 passing through the linear filter 1252. The signal input 1205 may be an estimate of the effect of the added probe signal at the input of the linear filter section, or it may be an estimate of the signal at the input of the linear filter section, or it may be the signal fed to the playback device or it may be the added probe signal, or it may be an estimate of the signal coming out of the playback device. The signal 1208 may be an estimate of the output signal of the linear filter section or it may be an estimate of the signal entering the recording device or it may be an estimate of the output signal of the linear section after addition of other sound/signal or it may be the signal coming in from the playback device.

In an embodiment, the parameters of the linear filter 1252 are chosen so as to minimize the error between the signal 1205 passed through the linear filter 1252 and the signal 1208. This may be done beforehand, or it may be done adaptively, during the running of the echo canceller. Adaptive algorithms such as the least mean square (LMS), recursive least square (RLS), QR-decomposition based adaptive filtering, Fourier domain fast adaptive filtering etc. may be used to perform this adaptation, and the parameters of the linear filter 1252 may either be time domain, Fourier domain, lattice coefficients, rational function coefficients (z-domain), etc., depending on the adaptive algorithm.

In another embodiment (depicted), the error minimization is not performed directly with respect to signals 1205 and signal 1208, but between two signals derived from them. Signal 1208 is passed through a linear filter 1241 to give signal 1245. The linear filter 1241 is chosen/adapted to minimize some function (such as the least mean square) of the signal 1245. The first coefficient of the linear filter 1241 is fixed at 1, and the other coefficients are allowed to vary/adapt. These coefficients converge to the (negative of the) best single-step linear predictor for signal 1208, and the linear filter 1241 thus becomes the prediction error filter, and the signal 1245 becomes the prediction error. The signal 1205 is passed through a linear filter 1242 which is a replica of the linear filter 1241, to give signal 1243. It is also possible to make the filter 1242 the prediction error filter and the filter 1241 the replica, it is also possible to insert a prediction error filter in both paths, and the replica in both paths. The parameters of the linear filter 1252 are chosen so as to minimize the error between the signal 1243 passed through the linear filter 1252 and the signal 1245, using any of the methodologies mentioned above.

The parameters of the estimated linear filter 1252 are provided to the echo remover to use as parameters of the linear filter in the echo remover.

It is also possible to use the fast Fourier transform to do block based least mean square adaptation of the linear filter 1252 and also of the prediction error filter 1241. For example, for the filter 1252, we wish to minimize

E [((signal1245)−(signal1243)*h)̂2]

the derivative of which with respect to the ith filter coefficient hi, is

−2 E [((signal1245)−(signal1243)*h)(signal1243 (T−i)]

where signal1243 (T−i) stands for the ith past sample of the signal 1243. When many such updates for hi are added over a block of input values, the above term becomes the ith coefficient of the crosscorrelation of the error signal and the signal 1243. Both the error signal itself, as well as this cross correlation can be calculated fast using the fast Fourier transform, and thus the speed of computation may be increased. After such update has been performed, the new adapted filter may be used to perform the adaptation computation again, multiple times.

The job of filter 1241 is to make a decorrelated version of the signal 1208. A single step linear prediction error filter is one way to achieve this. A multi-step linear prediction, Wiener prediction, lattice prediction etc. may also be used.

FIG. 13 depicts an echo canceller 1399, according to one embodiment. The following blocks are present in this embodiment:

General

Signal 1301 is the incoming signal.

Signal 1303 is the signal fed into the playback device 1304.

Signal 1305 is an estimate of the effect of the added probe signal at the input of the linear filter section of the environment model.

Signal 1308 is an estimate of the output signal of the linear section of the environment model after addition of other sound/signal.

Signal 1309 is an estimate of the input signal to the linear filter section of the environment model.

Signal 1311 is the signal recorded by the recording device 1310.

Signal 1312 is the outgoing signal.

Probe Signal Adder

Probe signal generator 1326 generates the probe signal 1327.

Non-linear block 1346 is a replica of the non-linear block 1351, whose output when subtracted from signal 1309 produces signal 1305.

Linear Filter Estimator

Linear filter 1342 is a replica of linear filter 1341.

Signal 1343 is the output of linear filter 1342 when the signal 1305 is fed to it.

Linear filter 1347 is adapted to minimize the mean squared error between its output signal 1344 and the signal 1345.

Linear filter 1341 is a prediction error filter adapted to minimize the error in its single forward step prediction of signal 1308.

Signal 1345 is the error in the prediction, i.e. the output of the prediction error filter 1341.

Echo Remover

Non-linear block 1351, an estimate of the non-linearity before the filter in the environment model, is adapted to minimize the mean squared error in signal 1322.

Linear filter 1352, an estimate of the linear filter in the environment model, is a replica of the linear filter 1347.

Signal 1321 is an estimate of the output of the linear filter in the environment model.

Non-linear block 1323, an estimate of the inverse of the non-linearity after the filter in the environment model, is adapted to minimize the mean squared error in signal 1322.

Signal 1322, an estimate of the other sound/signal in the environment model, is the signal 1321 subtracted from the signal 1308. The signal 1322 directly becomes the outgoing signal 1312, or it becomes the outgoing signal 1312 after passing through a non-linear block which is the approximate inverse of the non-linear block 1323.

In certain cases, data is sent to the playback device in chunks, and is available from the recording device in chunks. For example, this happens in embedded/software applications with devices, device drivers, etc. Whenever data is being prepared to be sent to the playback device, the probe signal generator 1326 is used to generate the probe signal 1327 which is added to signal 1301 to create signal 1303. The signal 1301, signal 1303 and possible signal 1327 are saved for processing the recorded data. (It is also possible to compute the output of non-linear block 1346 in this playback phase itself, but the non-linear block will then be a replica of a slightly out-of-date non-linear block 1351. Furthermore, this slightly outdated block 1351 may also be used to create signal 1305 in the playback phase itself.) Later, whenever data collected from the recording device is available, the rest of the processing of the echo canceller takes place.

Uses

The present invention may be used in any situation where echo cancellation is needed, such as telephones, two-to-four-port networks, signal repeaters, telephony and internet telephony, speaker phones and conference phones, non-intrusive video conferencing, etc. The present invention may also be used in any situation where the effect of a signal is to be cancelled from another signal. Examples are ambient noise reduction, noise reduction, reduction of interference from power lines or known noise sources. The present invention may also be used to correct for defects in speakers (or playback devices) and microphones (or recording devices) since a higher fidelity of signal reproduction and of signal sensing may be achieved by the non-linear blocks which adapt to mimic the non-linear blocks in the environment model. Thus, even where echo or noise cancellation is not required, the present invention can be used to improve fidelity of devices.

1. A method comprising:
creating a first signal in an environment using a playback device,
wherein the playback device is passed a second signal picking up a third signal from the environment using a recording device,
wherein the third signal is affected by the first signal and a fourth signal present in the environment,
and creating an estimate of the third signal using an echo remover,
wherein the echo remover uses the second signal and the third signal to create the estimate of the third signal.

2. The method of claim 1, wherein the step of estimating the third signal using an echo remover further comprises estimating a model of the environment.

3. The method of claim 2, wherein the step of estimating the model of the environment comprises:
estimating a first nonlinearity,
estimating a linear filter,
estimating a second nonlinearity,
and estimating the behavior of the environment as a process which
applies the first nonlinearity to the second signal,
applies the linear filter to the output of the first nonlinearity,
adds the fourth signal to the output of the linear filter,
and applies the second nonlinearity to the result of the addition,
to give the third signal.

4. The method of claim 3, further comprising estimating the output of the linear filter by
applying the estimate of the first nonlinearity to the second signal,
and applying the estimate of the linear filter to the output of the estimate of the first nonlinearity.

5. The method of claim 3, further comprising removing an echo by
estimating the output of the linear filter,
applying a third nonlinearity to the third signal,
wherein the third nonlinearity is an estimate of the inverse of the second nonlinearity,
wherein the third nonlinearity is calculated using the estimate of the second nonlinearity,
and subtracting the estimate of the output of the linear filter from the output of the third nonlinearity,
to give a signal with the echo removed.

6. The method of claim 5 further comprising applying an estimate of the second nonlinearity to the signal with the echo removed.

7. The method of claim 3, further comprising removing an echo by
estimating the output of the linear filter,
applying an estimate of the second nonlinearity to the estimate of the output of the linear filter,
and subtracting the output of the estimate of the second non-linearity from the third signal,
to give a signal with the echo removed.

8. The method of claim 7 further comprising applying an estimate of the inverse of the second nonlinearity to the signal with the echo removed.

9. The method of claim 3 wherein estimating a nonlinearity comprises estimating the nonlinearity as a linear combination of a set of basis functions.

10. The method of claim 1 wherein the second signal is an addition of a signal intended for playback and a probe noise signal.

11. The method of claim 3 wherein the step of estimating the linear filter comprises estimating the linear filter so as to minimize the difference between
a fifth signal and
a sixth signal passed through the estimated linear filter.

12. The method of claim 11 wherein the fifth signal is the output of a prediction error filter applied to a seventh signal and the sixth signal is the output of a filter identical to the prediction error filter applied to an eighth signal.
